(19) United States
(12) Patent Application Publication
(10) Pub. No.: US 2008/0120955 A1
(43) Pub. Date: May 29, 2008

(54) Hybrid electric lawnmower

(76) Inventors: Delbert R. Lucas, Bowling Green, KY (US); Justin Lucas, Lynchburg, VA (US); Ryan Jay Lucas, Atlanta, GA (US)

Correspondence Address: SUITER SWANTZ PC LLO, 14301 FNB PARKWAY, SUITE 220, OMAHA, NE, 68154, US

(21) Appl. No.: 11/899,616

(22) Filed: Sep. 5, 2007

Related U.S. Application Data
(63) Continuation-in-part of application No. 11/670,932, filed on Feb. 2, 2007.
Application No. 11/670,932 is a continuation-in-part of application No. 11/550,104, filed on Oct. 17, 2006.
Application No. 11/550,104 is a continuation-in-part of application No. 11/550,476, filed on Oct. 18, 2006.

(51) Int. Cl. A01D 69/02; A01D 34/00

(52) U.S. Cl. 56/10.6

(57) ABSTRACT

A hybrid electric lawnmower is described which includes a hybrid mower able to operate on two differing DC voltages. The mower presently described includes a hybrid controller operable to drive a permanent magnet electric motor on a high voltage and a low voltage wherein the operating may select either DC or AC operation representing the low voltage or high voltage. The dual voltage motor has separate windings on the rotor, both of the windings operable to drive the motor whether selected to operate on DC or on AC. The user operable selection of AC or DC reconfigures the dual windings on the rotor in either series or parallel configuration wherein low voltage operation places the windings in parallel relationship and high voltage operation places the windings in series relationship.

### PRIOR APPLICATIONS

This application is a continuation in part of and claims priority to U.S. patent application Ser. No. 11/670,932 titled “Hybrid Electric Lawnmower” filed Feb. 2, 2007, which is a continuation in part of U.S. patent application Ser. No. 11/550,104 Titled “Hybrid Electric Lawnmower” filed Oct. 17, 2006, and is a continuation in part of and claims priority to U.S. patent application Ser. No. 11/550,476, titled “Hybrid Electric Lawnmower Having Dual Power Supply” filed Oct. 18, 2006.

### BACKGROUND OF THE INVENTION

The present invention is related to an electric lawnmower and more particularly to an electric lawnmower having a boost/conserve power feature and a dual mode power supply providing power to a lawn mower motor.

### BRIEF DESCRIPTION OF THE DRAWINGS

FIG. 1 is a perspective view of the hybrid mower with power boost conserve features of the present invention;

FIG. 2 is an exploded view of the hybrid mower of FIG. 1;

FIG. 4 is a close up view of the controls for the hybrid mower of FIG. 1 with the interlock handle switch activated;

FIG. 5 is a bottom view of the hybrid mower of the present invention depicted in FIG. 1 in combination with the AC power input plug;

FIG. 6 is a circuit diagram of one option of a power control circuit for use with the hybrid mower with boost conserve feature of FIG. 1;

FIG. 7 is a circuit diagram of one option of the power inverter and hybrid control depicted in FIG. 6 for the lawnmower depicted in FIG. 1;

FIG. 8 is one option of the power control circuit for use with the hybrid mower with boost conserve feature depicted in FIG. 1;

FIG. 9 is one option of the power control circuit for use with the hybrid mower with boost conserve feature for the lawnmower depicted in FIG. 1;

FIG. 10 is one option of the power control circuit for use with the hybrid mower with boost conserve feature as depicted in FIG. 1;

FIG. 11 is a bottom view of an alternative mower design having dual blade construction;

FIG. 12 is a schematic of one option of the power control circuit and motor design for one embodiment of a dual motor electric mower;

FIG. 13 is a schematic of one option of the power control circuit and motor design for one embodiment of a dual motor electric mower;

FIG. 14 is a schematic of one option of a dual voltage lawn mower;

FIG. 15 is a schematic of the dual voltage electric motor in parallel connectivity;

FIG. 16 is a schematic of the dual voltage electric motor in series connectivity.

### DETAILED DESCRIPTION OF THE EMBODIMENT

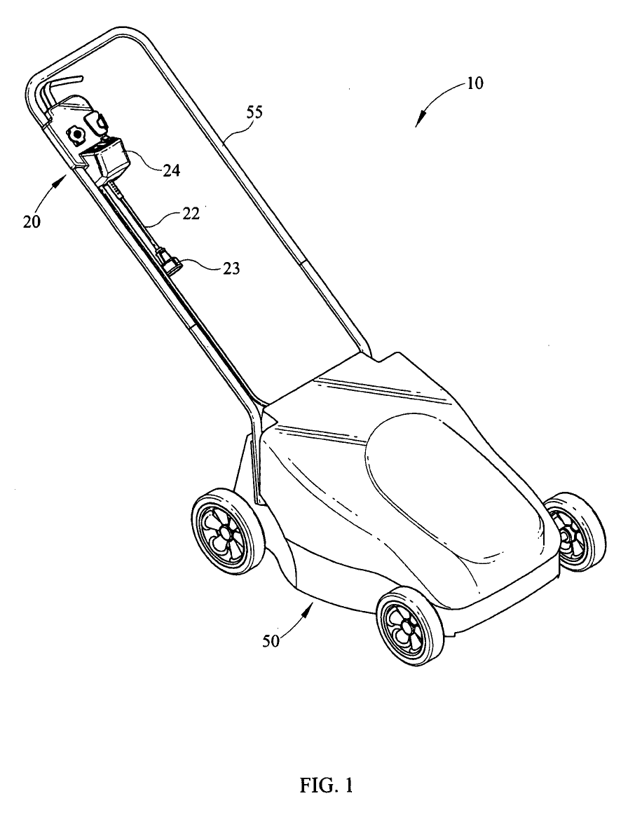

A hybrid electric lawnmower is described herein and set forth in the claims and is partially depicted in the perspective view of FIG. 1 wherein the hybrid on the outwardly extending handle 55 is a plurality of controls 20, the controls 20 incorporating a control box 24, an AC plug 22 and an AC receptacle 23. Additionally, contained within the deck 50 are a number of features including, but not limited to, the power control and supply described herein as well as a DC motor, a blade, and other necessary features for making the electric lawnmower described herein operable to function as desired. Such function and structure include the DC motor to drive the blade, the DC motor powered by alternative power supplies which include 120V AC line voltage or DC power supply such as a batter pack. The motor drives the blade and the power supply system of the hybrid electric mower allows the user to select the power source whether it be AC power supply or DC power supply. In either selection, the power control system of the electric mower provides adequate voltage to the motor. Further, a selection is available for the user of the present embodiment to drive the motor in either conserve or boost mode, conserve mode utilizing less power from the power source as boost mode thereby increasing run time for each full battery charge under such selection, should the DC operation mode be selected, although both conserve and boost mode may be operable in AC operating mode also.

Further design enhancements may include the addition of a second electric motor in order to increase the cutting width of the electric lawn mower without increasing the blade diameter. Increasing blade diameter is problematic in that the total amount of air resistance with longer blades increases substantially the power drain on the battery due to substantial air movement resistance.

Additionally, a single motor may be utilized which has the capability of dual voltages such that the electric mower of the present design can be run from both 120V AC and also from a battery pack. In either situation, the power supply will provide substantially the same voltage potential across a first and a second coil on the electric motor mounted to the mower housing. Both coils of the motor may be selectively configured through the use of a user selection switch which reconfigures the coils on the motor from series connectivity, for higher voltage source such as rectified line voltage, to parallel connectivity, for a lower voltage source such as a battery pack. The coils may be electrically separated on the armature with a commutator on each end of the rotor, a first commutator in electrical contact with a second coil and second brushes. By placement of the coils on the rotor to form the armature and maintaining electrical separation between the coils, an easy to implement design for a dual voltage, both high and low, motor may be achieved while making the motor more efficient since all coils are utilized regardless of the voltage source.

While many options and various embodiments are depicted herein for operation of the hybrid lawnmower with power boost and conserve features, it is to be understood that a wide variety of alternative structures may be utilized in order to incorporate the novel functionality and structures described and claimed. Further, while certain electrical connections and circuits are described for providing operable functionality, it is to be understood that one of ordinary skill in the art would understand the disclosure and functionality described herein, as well as the embodiments and variations described, and include or replace operative alternative structures to perform the same or similar claimed functional elements. As such, the embodiments and particular elements set forth in the description herein are not deemed to be restrictive and are merely provided within the limits of the teachings hereof to be exemplary and should not unnecessarily narrow or limit the controls and electronics which are used to describe various embodiments and examples set forth.

The hybrid mower with a boost conserve feature of the present embodiment is depicted in FIG. 1 with the deck 50 on a plurality of wheels such that the hybrid mower 10 may roll, be powered or be pushed over terrain required to be cut by the blade 51. The specific configuration of the hybrid mower 10 of the present embodiment, as depicted in FIG. 1, is not necessarily limiting in that the many structures and switches which are depicted may be positioned on multiple surfaces or in multiple positions on the hybrid mower 10 and thus, the particular location and limitation of the depictions and structure set forth are considered to be merely exemplary.

The hybrid mower 10 of the present embodiment incorporates controls near the handle 55 such that they may be readily accessible to the operator of the mower 10. These handles and controls, more clearly and specifically disclosed in FIG. 3, include a power selection switch 21, a boost and conserve switch 26, both of which may be located on the control box 24. Integrated within the control box 24 may also be a circuit breaker 28, a clutch release 32 and a blade clutch handle 31, the blade clutch handle 31 acting as an interlock handle switch to engage and disengage the DC motor 56 from rotating the blade 51. Also shown with the controls 20 on the control box 24 is the AC power line 22 which may be directly plugged into AC line voltage which is typically 60 Hz 120 Volts. The AC power line 22 has a plug receptacle 23 for directly connecting to an extension cord or other device in order to provide AC electrical power to the hybrid mower 10 of the present embodiment.

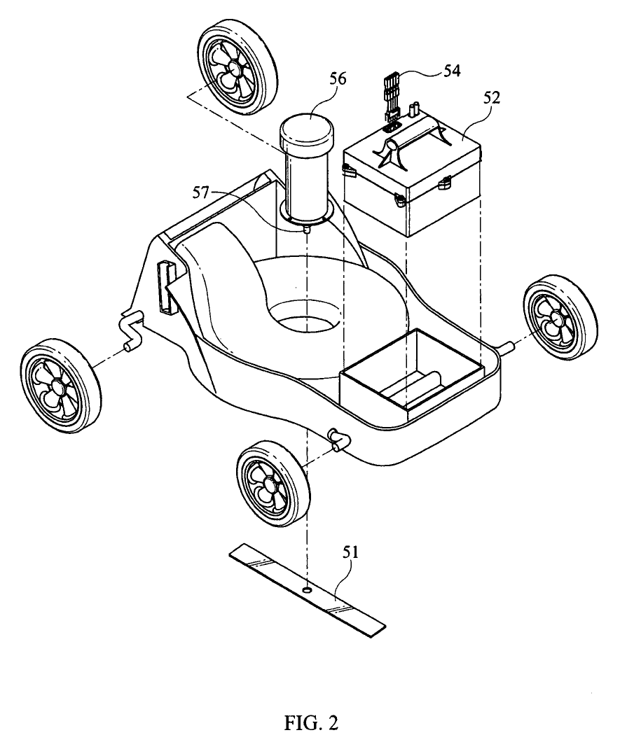

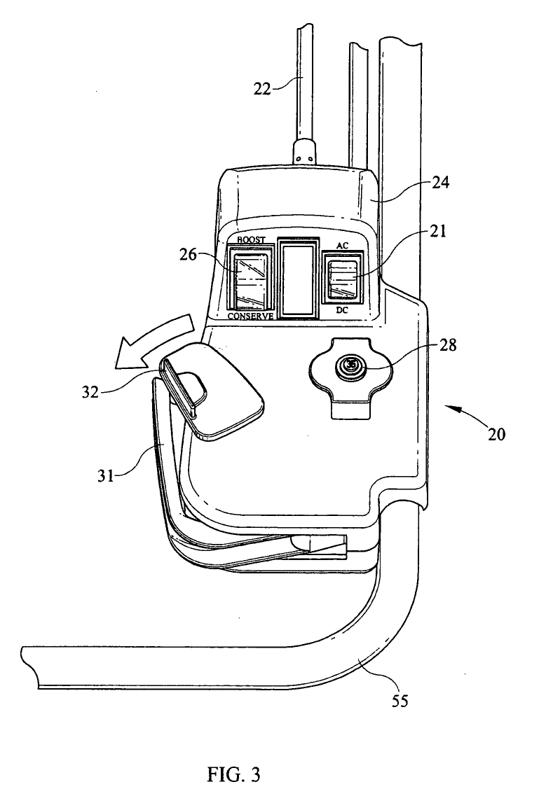

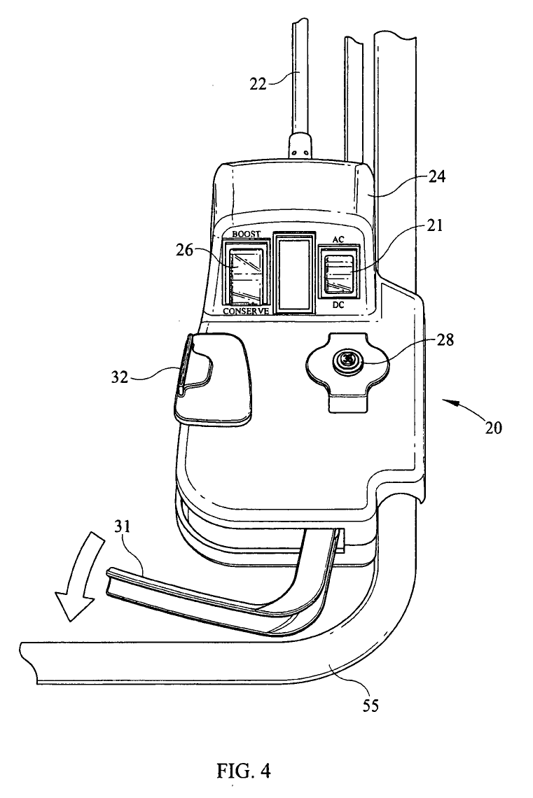

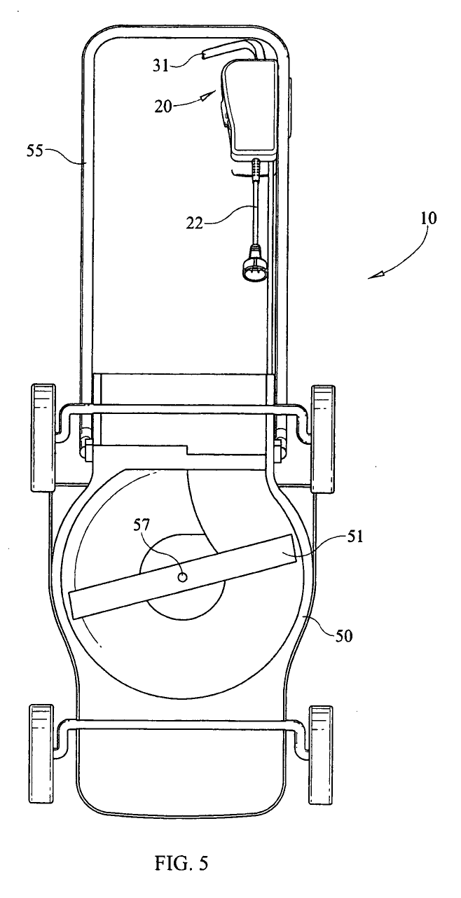

The hybrid mower 10 of the present embodiment is designed to be operated on either AC line voltage from an AC power source such as a wall plug or other AC source, or from a DC battery pack which is mounted on the deck 50 or in close conductive and operative relationship with the DC motor 56 depicted. The hybrid mower 10 of the present embodiment is so designed that the operator may operatively select functionality of the hybrid mower 10 and the motor 56 by either AC or DC power, the DC alternative coming from the battery pack 52 which may be rechargeable. The rechargeable battery pack 52 is mounted, as depicted in FIG. 2, on the deck 50. Additionally, as depicted in the controls 20, the hybrid mower with boost and conserve feature 10 of the present embodiment includes an option a boost conserve switch 26 which provides the functionality of increasing or decreasing the voltage provided to the DC motor 56 thereby increasing or decreasing the rotational speed of the blade 51 based upon the setting of the boost conserve switch 26. As can be commonly understood, the boost conserve switch 26 may increase or decrease the voltage and thereby increase or decrease the actual drain on the battery pack 52 or other power supply due to the increased current provided to the DC motor 56. Thus, as the hybrid mower with power boost conserve feature 10 of the present embodiment is run in the DC power selection option depicted by the DC selection shown in FIG. 3 and selected by the power selection switch 21, the battery pack 52 may be brought in electrical conductivity with the DC motor 56 and the boost and conserve switch 26 may be placed in a conserve switch setting so as to reduce the rotational speed of the blade 51 thereby decreasing the rate of drain of the battery pack 52 and also increasing the run and operation time of the hybrid mower 10 of the present embodiment per charge. Alternatively, the DC motor running Thus, the boost and conserve feature as shown and depicted in the examples and as is effectuated in the present embodiment through the use of the boost conserve toggle switch 26 of FIG. 3 may be integrated with either power selection of the AC power input line or DC power input line to the DC motor 52. Further descriptions and implementations of such examples will be described hereinafter.

As shown in FIG. 3, the controls 20 of the hybrid mower 10 of the present embodiment is depicted with a blade clutch handle 31 and a clutch release 32 such that the blade clutch handle 31 must be operatively held in close relationship to the handle 55 as is commonly understood and known by those of skill in the art in order to engage the DC motor 56 and correspondingly the blade 51. The blade clutch handle 51, when placed and held in close relationship to the handle 55 of FIG. 3, engages an interlock handle switch as will be described herein which may be a double throw switch, and which operates to act as a user's dead man switch in order to disengage the DC motor if released. It is desirable in order to be able to discontinue rotation of the blade 51 upon release of a manually actuatable handle within a limited and short period of time. Thus, the interlock handle switch as depicted herein is integrated with the blade clutch handle 31 and acts to operatively disengage the DC motor and also cause resistive breaking of the motor and thus the blade upon release of the handle 31.

Turning now to particular embodiments and examples as depicted herein, the present embodiment is directed towards a hybrid electric lawnmower which has a boost and conserve feature. Electric lawnmowers, and particularly battery powered mowers, have historically had limited mowing time per charge and have had increased weight due to the battery pack. Thus, prior alternatives had been a corded electric mower with the corresponding restriction of managing a cord and limited power from the household current. When operating off the battery pack, it has been difficult to mow larger lawns due to the limited mowing time per charge and possibly due to greater height of the lawn which would correspondingly reduce the charge and run time for the battery pack.

In the present inventive hybrid mower 10 depicted, the hybrid control system depicted allows for the hybrid mower 10 to be powered from regular household have a lower operating voltage available which may be lower than the average peak voltage of the household current. This arrangement may be provided in order to allow the mower to run in a possible conservation mode in order to preserve battery run time under less demanding grass conditions. Alternatively, when the mower is plugged in to AC household current or line voltage or when additional voltage is tapped from the battery pack or from a battery associated with the battery pack, the hybrid mower 10 of the present embodiment may selectively be operated in a boost or power mode, the boost mode allowing the mulching of taller grass or pick up various debris or pine cones from the yard during operation.

It may also be desirable in one of the present inventive embodiments, to provide a battery pack 52 which is easily removable from the lawnmower deck 50, as is depicted in FIG. 2. The hybrid mower 10 of the present embodiment may be used without the battery pack so as to be more easily maneuverable in sloped areas due to the reduced weight of not having the battery pack 52 installed. It may also be easier to stow the mower and charge the battery pack 52 separately or alternatively charging the battery when the mower 10 is still in operation. The DC motor 56, depicted in FIG. 2, may be a permanent magnet type DC motor and may be designed to receive power from the battery and/or from the hybrid power controller which will be described herein. The DC motor 56 may be provided to power the rotating blade 51 while cutting vegetation and the motor 56 may act as a generator in order to provide resistive breaking after deactivation of the inter-lock handle switch described thereby providing a resistive load to stop the blade quickly once the blade interlock handle 31 is released. The motor 56 shown in FIG. 2 may be designed to further provide a fan to promote cooling of the DC motor 56 thereby providing air circulation across the brushes and through the motor. Alternative embodiments with multiple motors or with multiple commutators selectively operating in series or in parallel may also be provided.

As previously described, the blade 51 may be provided in order to mulch or cut vegetation. Typical blade tip speeds of about 16,000 to 19,000 ft. per minute non-cutting with a blade tip speed during cutting of vegetation of between 12,000 to 18,000 ft. per minute with a proportionate horsepower rating for the DC motor of about 1.5. Higher be recognized operating off of Battery DC voltage. Alternatively, in a low power or conservation mode, the run time can be considerably longer with a battery life expected to be increased by 50% and wherein the speed of the DC motor 56 correspondingly decreases to drive the blade 51 at approximately 14,000 ft. per minute blade speed as measured at the tip of the blade. The various speeds of the blade 51 can correspond to a plurality of voltage outputs from the hybrid power supply as seen by the DC motor 56. Namely, to provide higher speed functionality of the blade, a voltage of sixty-six or seventy-two volts DC may be presented to the DC motor with a 300 watt/hr batter charge capacity. Alternatively, in conservation or low speed mode, thereby corresponding to higher battery pack run time duration or less current draw from the power supply, the power consumption may be significantly reduced by providing 60 volts or less to the DC motor 56. These various power consumption modes may be provided through the use of the boost and conserve selection switch 26 which, as can be seen from the examples depicted herein, may be a single pole double throw switch as shown in order to increase the voltage through the various means depicted and described in the multiple examples hereof.

Thus, in conservative mode the corresponding blade speed may be less than 15,000 ft. per minute blade tip measurement and preferably at 14,000 ft. per minute blade tip measurement or less thereby significantly increasing the battery pack charge run time should the battery pack be in operation and the power selection switch 21 be selected in DC mode as depicted in FIG. 3. In such an instance, the 60 volts may be provided to the DC motor which, as depicted in the embodiment of FIG. 2, the battery pack 52 may be provided with a series of five batteries connected in series, each of the batteries providing 12 volts. Alternatively, should the boost/conserve switch 26 be operated in the boost mode while the power switch 21 is in the DC mode, and additional or secondary battery which may be integrated with or separated from the battery pack 52 depicted in the exemplary drawing, may be brought in series with the battery pack 52 power supply thereby increasing the voltage to 66 or 72 volts, depending on the ultimate desirability and blade speed to be operated. Of course, variations may be provided in the configuration and implementation while running in DC mode for the battery pack many other embodiments including bringing batteries in parallel, series, or providing additional power sources may be utilized.

While this example of the conserve and boost switch has been provided in the operation of DC mode, alternative embodiments and increase in motor speed may be provided while also running in AC mode will be described herein. Such embodiments may include increasing the step down voltage from the power supply controller as presented to the DC motor or alternatively bringing in series the secondary battery while also operating in AC mode thereby increasing the DC voltage presented to the motor and resulting in an increase rotational speed of the blade. Thus alternative embodiments are shown and depicted wherein the power supply of the present embodiment generates DC power to the motor and wherein the boost or increased voltage may be derived from either the power supply by various techniques known and depicted, or by providing additional voltage from the battery pack or secondary batter, either of which may result in increased operational speed of the motor and blade speed.

One other aspect of the present embodiment of the hybrid mower 10 of the present embodiment is the ability to provide a user selectable power supply to a DC motor driving the blade 51. In the presently depicted hybrid mower 10 of the present embodiment, a DC motor 56 is provided to rotate blade 51 on the mower deck 50 due to its energy use and supply characteristics. A user selectable alternative power supply or power selection switch 21 is provided in order that the DC motor 56 may be user switchable from power sources, namely from an AC 120 volt 60 Hz power input representing line voltage should an extension cord or line voltage be readily accessible or alternatively, to a battery pack DC voltage provided on board of the mower, both power supplies selectable by the operator and both power supplies driving the same motor mounted on the lawnmower housing or deck 50. Such an option is highly desirable and unique in that the user may selectively operate the mower from various user selectable inputs representing alternative power inputs, a first power input being provided at the power selection switch 21 representing a power input line from a battery pack 52, and a second power input being provided at the power selection switch 21 representing the AC line 22. Further, as an alternative design element, the power control circuit 60 could detection to activate a triac or other relay device to automatically connect the electric motors to line voltage, when plugged into the power control circuit. Such user selectable power selection can thus be automated by a automated voltage or other detection circuit or may be actuated by the switch 21 herein described.

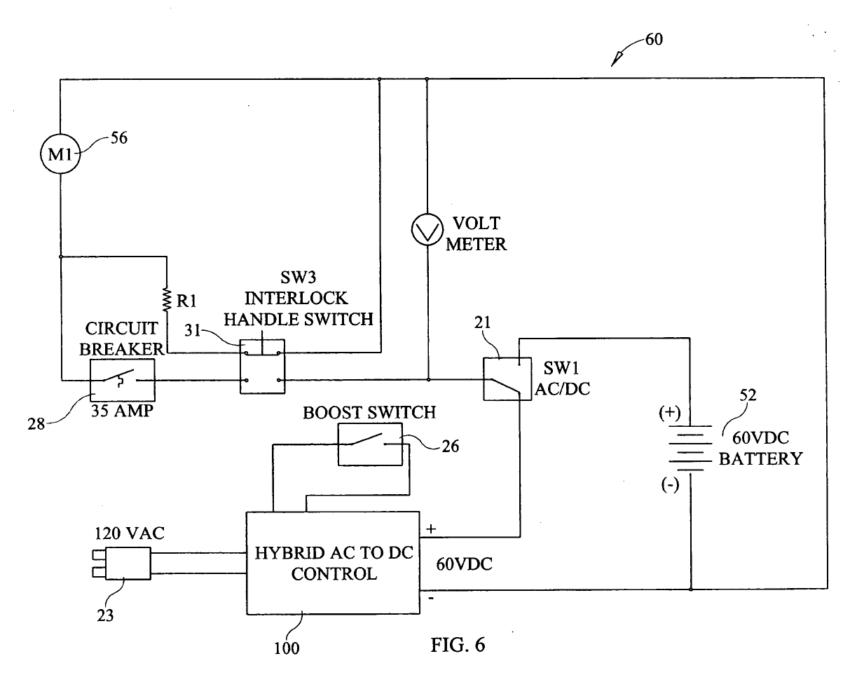

Turning to an exemplary embodiment shown in FIG. 6 wherein a power control circuit 60 is depicted providing, among other things, the boost and conserve power features of the present embodiment. The DC electric motor 56 is shown in electrical connectivity with the various power control circuit elements 60, 100 which include the inter-lock handle switch 31, for example being a double pole double throw switch, a circuit breaker 28 being, as depicted herein, a 35 amp breaker, a boost/conserve switch 26, in this example being a single pole double throw switch, a power selection switch 21, in this example being a single pole double throw switch, a battery pack 52 which is depicted as a 60 volt DC battery pack providing 60 volts presented to the motor 56 when operatively selected by the power selection switch 21, and a hybrid AC/DC controller 100 which serves as a power inverter or step down controller for converting the line voltage 120 V AC presented by the plug 23. The battery pack is shown as sharing a common ground with other portions of the power control circuit but may be in electrical connectivity with the power control circuit in many known and understood manners without actual connected electrical wiring as long as the user operation of the lawn mower is actuated through activation of the various switches. In this present example, the boost selection switch 26 provides an increased voltage to the motor 56 by virtue of modifying an input resistive value or timing signal value to the pulse width modulation control unit 120, which will be described herein, in order to alter the gating of the IGBT thereby affecting the voltage wave form at the output of the power inverter or step down controller 100. The in rush current limiter may be provided as shown in order to prevent oversaturation of the circuit during the initial startup and energizing of the circuit. The rectifier 110 as is commonly understood rectifies the voltage from AC to DC, in this case utilizing a full bridge rectifier as shown. However, many different forms of providing a step down controller are known in the art and the depictions set forth are not to be considered unduly limiting. connects to the hybrid AC/DC controller 100 acting as a voltage converter which in turn is connected to a single pole double throw power selection switch 21 and a single pole double throw boost switch 26. The boost switch 26 is the boost conserve switch depicted and described herein and it provides resistive loads to the CMOS micro-controller for the pulse width modulation control 120 depicted when selected and opens the contacts when off. The power selection switch 21 toggles the DC motor between the output of the step down controller 100 and the DC battery voltage source 52. The output of the power selection switch 21 feeds a voltage meter shown which may be connected in parallel with the double pole double throw inter-lock handle switch 31, the inter-lock handle switch 31 toggling between shorting the DC motor 56 through resister R1 to ground and connecting the output of the power selection switch 21 through a circuit breaker 28 to the DC motor 56.

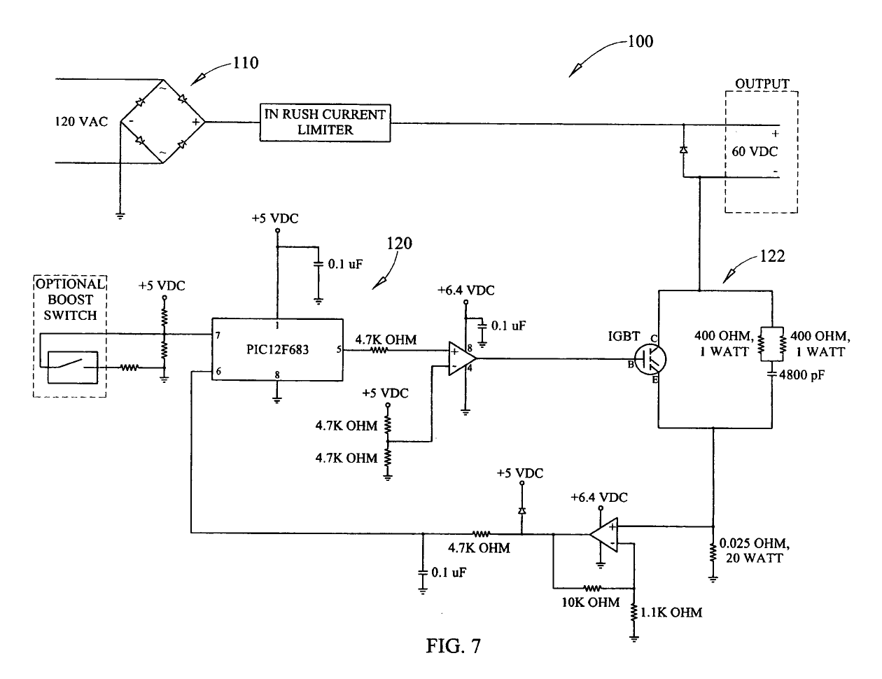

In this embodiment as depicted in FIG. 6, the boost switch 26 may provide increased voltage to the motor 56 when the hybrid mower 10 of the present embodiment is plugged in and running off of line voltage AC power. Such boost may be effectuated by modifying the pulse width modulation control 120 through alteration of the input resistive load at input pin 7 of the micro-controller shown in FIG. 7. More description of the power inverter and/or step down controller 100 of the presently inventive power supply will be set forth herein.

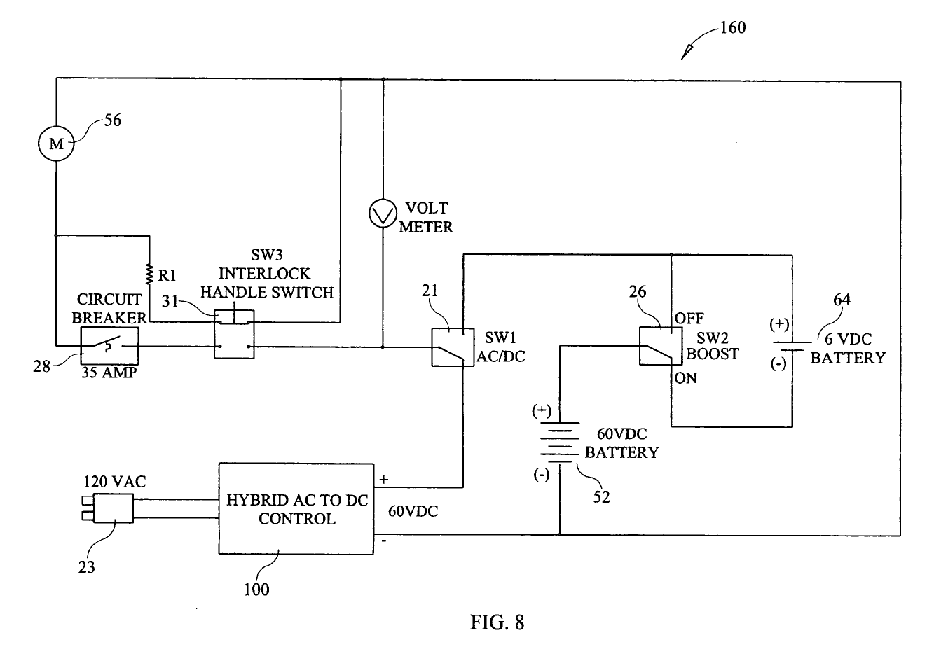

Turning to an additional embodiment for the power supply circuit 160 of the present embodiment in FIG. 8, this embodiment provides an AC wall plug 23 which connects to an AC voltage to the hybrid AC/DC controller 100 which in turn is connected to the power selection switch 21 which allows toggling between output of the AC/DC hybrid controller 100 when in the AC selection and to a boost conserve switch 26 and alternative power source when in the DC position. The boost conserve switch 26 toggles between shorting the positive side of the battery source 52 directly to the boost switch 26 went off and connecting the battery source 52 in series with the secondary or boost battery 64 before connecting to the power selection switch or AC/DC switch 21. The power selection switch 21 then feeds a voltage meter V which is connected in parallel with an inter-lock handle switch 31, here depicted as a double pole double throw switch. resistor R1 to ground and connecting the output of the power selection switch 21 through the circuit breaker 28 to the DC motor 56.

As depicted, in the example shown in FIG. 8, additional voltage is provided to the DC motor 56 when the hybrid mower is positioned in the DC power selection option and activation of the boost switch 26 thereby providing an additional 6 volts DC to the 60 volts DC provided by the battery 52. A secondary battery 64 provides additional voltage to the motor thereby increasing the motor speed and corresponding blade speed through actuation of the boost/conserve switch 26 to the boost setting. Thus, the power control circuit or power supply 160 depicted in FIG. 8 allows the operator while in the DC battery operation mode to increase the operating speed of the motor 56 corresponding to the additional voltage provided by the secondary battery 64. Controls are also provided allowing the operator to select between the operation of the motor 56 through the use of line voltage, namely 120 V AC, or through the use of the battery pack 52. Depicted herein is a secondary boost battery 64 which is provided as separate to the battery pack 52, but it may be more practical to provide a secondary boost battery 64 in combination with and contiguous to the battery pack 52 as assembled and shown in the figures. Thus, the secondary boost battery 64 may be continuous with the battery pack 52 or may be separate but is provided to add additional voltage to the motor 56 in order to modify the operating output voltage of the power supply as presented to the motor 56.

The hybrid AC/DC controller 100 as shown provides both power inverter and step down capabilities in order to modify and regulate the 120 V AC to the proper voltage required to run the DC motor 56. However, these functions are provided to be only exemplary. The controller 100 acts as an inverter via rectifier 110 and also to properly modulate the voltage via the PWM controller 120 and associated gates. The power inverter and step down controller 100 may be part of the power supply or power control module 60, 160, 260 and 360 as needed, or may be excluded, depending on the voltage characteristics of the input line voltage and the requirements of the electric motor implemented in the present design.

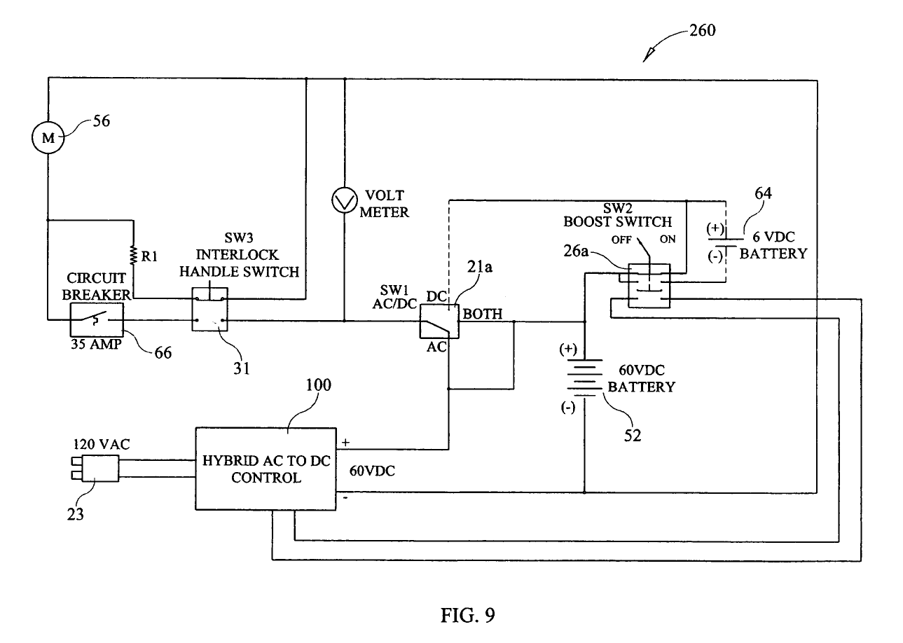

An alternative construction for the power control is the power supply circuit 260 depicted in FIG. 9 wherein both 120 V AC may be provided to supply power selectable by the user through the power selection switch 21a. As depicted in this example, the boost switch 26a is operative to bring in series a secondary battery 64 which is 6 volts DC (when set in “BOTH” mode) with the voltage provided by the hybrid controller 100 of the power supply or the battery pack 52. The secondary battery 64, as previously described and as depicted in this embodiment of the power control circuit 260, may be in combination with the battery pack or secondary and separate thereof. Additionally, as shown in the example, the 6 volt battery is brought into the circuit in series with the DC output of the hybrid control 100 or with the battery pack 52. Also, many variations for the structure, assembly and actual value of the secondary battery 64 for all embodiments may be provided in order to increase the voltage to the motor 56. As depicted in FIG. 9, the power selection switch 21a further provides for three settings allowing user selectable options of powering the DC motor 56 by either 120 V AC, direct battery pack connection or a hybrid BOTH connection. When operating in the strictly 120 V AC mode, the hybrid AC to DC control 100 is depicted regulates and modulates the voltage for proper supplying of voltage to the DC motor 56. Alternatively, the power selection switch 21a provides for a DC operation whereby the motor 56 is operated merely by the battery pack 52. A third option is placement of the power selection switch 21a into the BOTH mode wherein there may be a limited amount of power contribution from the battery. In such instance, voltage drops caused by increased load on the motor 56 may result in increased contribution from the battery pack 52. Additionally, as depicted in the embodiment shown, the boost conserve switch 26a may be provided for contribution of additional voltage from the secondary battery 64 when the power selection switch 21a is placed in either the BOTH or DC mode. In such an instance, the secondary battery 64 is brought in series with the voltage contribution from either the power supply 100 or the battery pack 52.

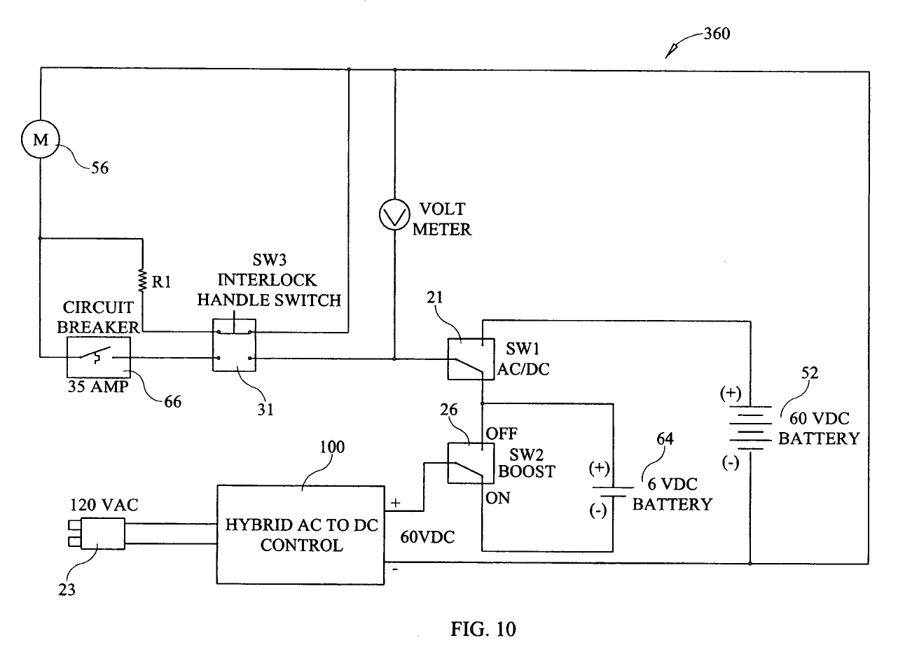

Turning to FIG. 10, an alternative construction and embodiment of the power control and supply circuit 360 is depicted. In the example depicted, the power supply circuit 360 consist of a 120 V AC wall plug 23 which connects to the hybrid AC controller 100 which in turn is connected to an exemplary single pole double throw boost switch 26 thereby allowing the circuit to bypass boost battery 64 when off or be exemplary single pole double throw power selection switch 21 which toggles between output of the speed selection switch 26 when in the AC position and the DC battery voltage source 52 when in the DC position. The power selection switch 21 feeds a voltage meter V which is connected in parallel with an exemplary double pole double throw inter-lock handle 31, the inter-lock handle switch 31 toggling between short in the DC motor 56 through a resistor R1 to ground and connecting the output of the power selection switch 26 through a circuit breaker 66 to the DC motor 56. In this example of the power control circuit 360, the boost or secondary battery 64 is brought in parallel with the power pack 52 or with the output of the hybrid controller 100 which may increase the current capacity for the motor when in higher speed or boost mode.

Multiple variations of power control module or power supply may be provided and are described herein. When mentioned herein as a hybrid power controller, power supply, power control module, step down controller or hybrid controller, these terms are collectively meant to imply providing electricity to the motor placed on the mower housing. No single element set forth in the exemplary embodiments provided herein, namely the power supply elements of the switches, battery packs, circuit breakers, inverters and modulation elements are to be unnecessarily applied to the interpretation of these terms. In fact, the power supply circuit collectively described herein may be implemented through the use of a significant number of alternative structures for regulation, modulation, controlling or limiting the proper voltage or power to the motor implemented in the examples herein. No unnecessary limitation should be interpreted from the particular use of the term controller, inverter, regulator or regulation or modulation as depicted herein, as one of ordinary skill in the art would be enabled through the teachings hereof to provide significant variations to the particular embodiments and examples disclosed in the figures and stated in the described examples.

Turning to the exemplary power inverter and in combination step down controller 100 which acts as a portion of the power control module, the hybrid controller 100 receives as input 120 volts AC which, in this example, is inverted utilizing a full bridge rectifier 110 depicted in FIG. 7. An in rush current limiter is provided also to prevent current surges during initial loading of the circuit and prevent further damage or voltage rectification. As depicted in the present example, a full bridge rectifier may be utilized but this may be replaced with other known inverter circuitry as is available and known in the art.

In addition, as depicted in FIG. 7, an optional boost switch may be provided which may correspond to the boost switch 26 depicted in FIG. 6. In the present exemplary embodiment, the boost switch may be operable to modify the input to the pulse width modulation controller 120 which defines the voltage output for the step down controller 100. As shown, a micro-controller is utilized in order to set the appropriate pulse rate for the PWM control and feeds into the insulated gate bi-polar transistor (IGBT) which provides the switching or pulse gate driver 122 for the DC output of the hybrid AC/DC control 100. Thus, the hybrid controller 100 incorporates, but does not necessarily require, the utilization of voltage rectification and a voltage rectifier as is necessary in combination with variations of voltage modification such as a pulse width modifier. However, multiple options for step down voltage and control are known and may be utilized such as diode controls, triac controls, MOSFET controls and the like. Many of these are well known in the art and may be utilized in the step down controller and power inverter in combination as described herein. Additionally, as depicted, the pulse width modulation control circuit 120 receives as input in one possible embodiment the ability to modify the voltage by use of the boost switch. The boost switch in this embodiment modifies the reference signal fed into pin 7 of the micro-controller for the reference value which operates to modify the gating of the IGBT and therefore, the voltage characteristics of the DC output depicted. The boost mode depicted provides the alternative function of a boost integrated with the power inverter and step down controller. As shown integrated with the controller 100 in FIG. 6, the boost switch can be alternatively provided in many connections and this integrated boost switch may be integrated with many of the other alternative embodiments.

As is known, many variations of a step down controller and inverter may be utilized and in general, the power control module of the present embodiment may utilize power input of 120 V AC and which incorporates many switches and controls for electrically connecting the DC motor to either the 60 volt DC battery or the DC output of indicated wherein the power source switch effectively has a first power input as a connection of the power control module of the DC output of the power inverter and step down controller 100 or receive as a second input the 60 volt DC of the battery pack, the power selection switch providing the ability of the operator to switch between 120 V AC power and 60 VDC power from the battery pack. The power selection switch may be directly connected to the DC motor, in this exemplary embodiment a 60 volt DC motor which operates the blade. The 60 volt DC motor may be operationally modified by utilization of a boost switch which is optional in many embodiments depicted herein, the boost switch changing voltage applied to the DC motor from 60 volts by an incremental value thereby increasing rotational speed of the blade as necessary by the operator. Such increase in blade speed, as previously indicated, may be necessitated by thicker grass or due to other items necessarily being mulched by the hybrid mower 10 of the present embodiment. This boost/conserve function which is shown herein provides the ability through the many embodiments disclosed to increase the voltage of the power control module and thereby increases the rotational speed of the blades. As indicated, this may be desirable for short periods of time and may provide a first power output of the power control module, the first power output higher than a second power output, the second power output being a conserve feature wherein the DC motor draws less current and thereby increases the battery life charge of the battery pack. However, such feature does not have to be implemented, as is clearly seen herein, only with the use of DC operation and DC power input as it is apparent that the increase rotational speed (boost) feature may be implemented also with 120 V AC wall power by increasing the DC voltage output of the hybrid AC/DC control 100 or by adding supplemental DC power supply from the operating batteries, whether the primary or secondary.

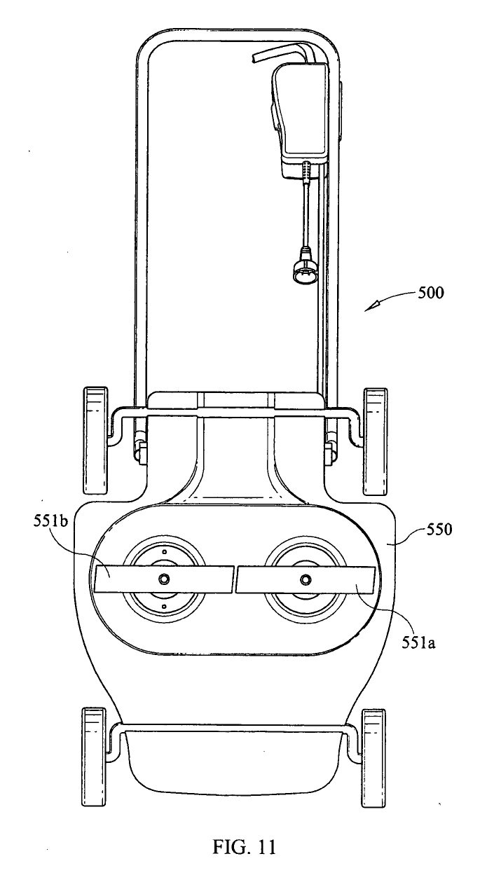

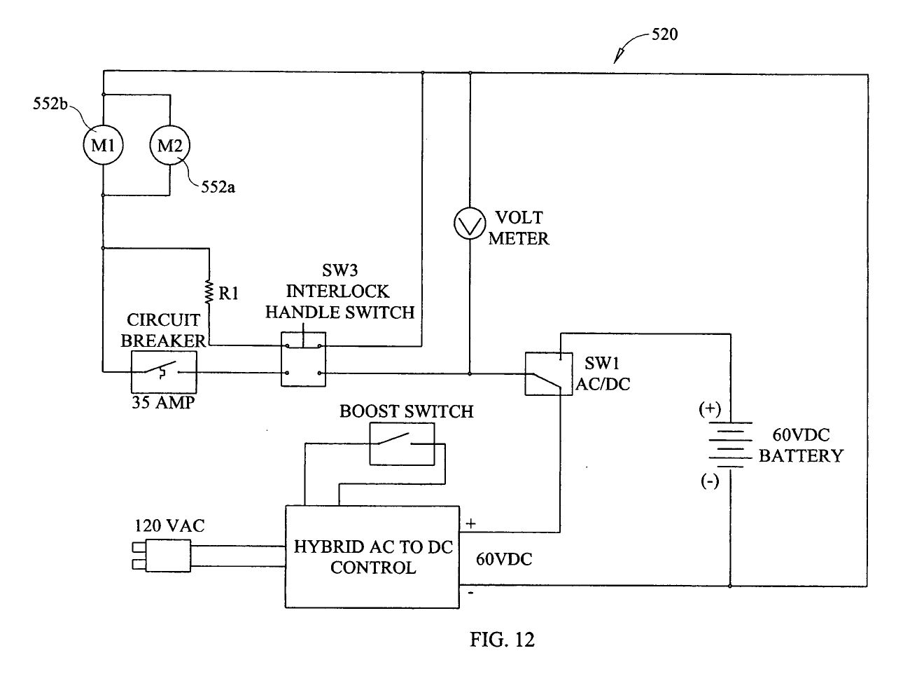

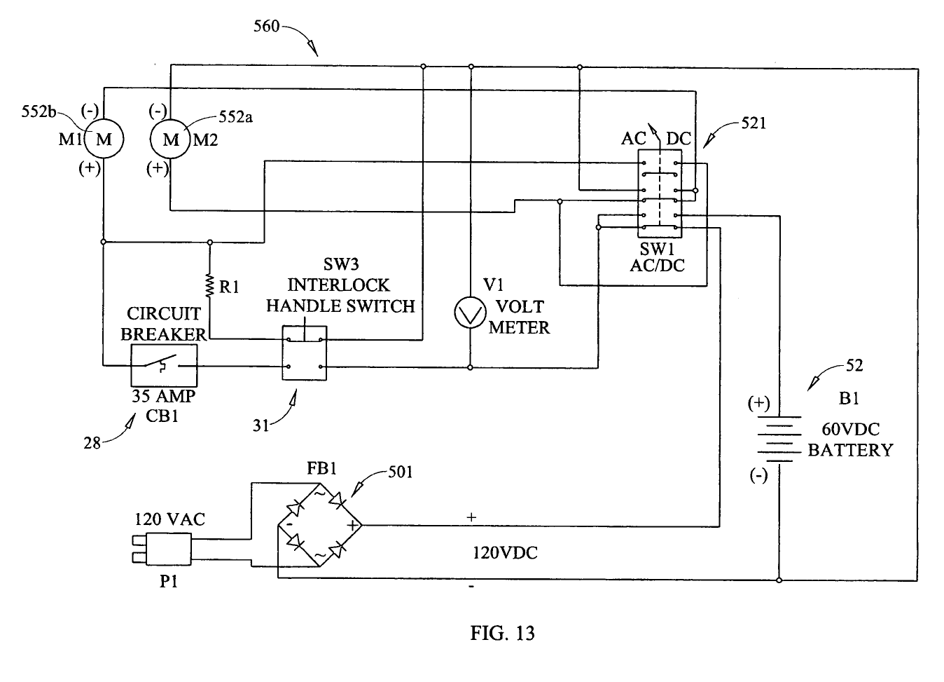

Turning now to FIGS. 11-13, an alternative embodiment of the electric lawnmower of the present invention is depicted. In such an alternative construction, the electric lawnmower 500 has a first and a second blade 551A and 551B mounted to a housing 550. Driving each of the blades, 551A and 551B are a first and second motor 552A and 552B as depicted in FIGS. 12 and 13. As is commonly understood, the dual motor alternative construction as is depicted, may substantially use similar power control and 552B to the power supply voltage. As is understood, it is desirable to provide the DC motors with either 120V AC line power which is current rectified or with the battery pack supplied DC electrical power. In the construction and multiple embodiments provided, two blades may be provided to cut vegetation within and below the deck 550 of the electric lawnmower 500. A total cutting width of approximately 21 inches may be provided wherein each of the blades may be about 10.4 inches. As is commonly understood, by attempting to cut a relatively large diameter with a single blade, such as the entire 21 inches of the housing width, excessive battery drain and power consumption will be experienced due to the known issue of air movement resistance encountered by the blade. The air movement load goes up exponentially as related to the blade speed thus adding a significantly higher load in addition to the normal vegetation cutting resistance load. The faster the blade rotates and the longer the blade causes a significant proportion of the power supply to be used in movement of air as opposed to cutting of vegetation. Thus, for cutting of wider diameters, it may be preferable to utilize two motors and blades working in tandem. By utilizing two motors as opposed to a single motor with an increased rotational speed, significant power savings may be experienced and run time lengths for the power supply battery as well as power consumption in both DC and AC operations will be significantly reduced. Additionally, as is known in the art, when using dual motors 552A and 552B, such dual motor implementation may preferably not be used in series in conjunction with battery operation due to the motors running at half speed, i.e. sharing the battery pack supplied voltage in series. Thus, in preferred implementation, although not necessarily required, for dual motor use, the DC electric motors may be preferably placed in parallel as is depicted in FIG. 12 in certain operations, such as when operated by the battery pack, and possibly in series in others, such as when connected to higher line voltage. However, the DC motors may be placed in either operation as is deemed necessary. Also, power usage may not become an issue when providing line voltage through the hybrid AC to DC controller wherein the AC current is rectified for operation of the DC motors depicted.

As depicted in FIG. 12, the dual DC motors 552A and 552B for the power control and supply system 520 of the present embodiment, depicts the DC motors interlock handle switch as previously described in order to operationally connect and disconnect the motors as selected by the user through the blade clutch handle 31. Further, an AC/DC operational switch may be provided for selection of either power supply, either AC line voltage or DC battery power supply as previously described. Further, a hybrid AC/DC controller may be utilized to implement rectification of the 120 V AC to adequate supply of DC current to the motors 552A and 552B. Further, the boost switch may be provided in combination with the hybrid controller or separately as previously described as combinations of these individual elements may be selected to one of ordinary skill in the art and generally is considered to be taught within the operational specifications hereof.

In an embodiment, the dual blade DC motor combination may provide a 21 inch path of cutting vegetation wherein similar rotational speeds of 16,000 to 19,000 feet per minute blade speed may be experienced either on battery or on the AC line voltage with the higher rotational speed indicated when operating using line voltage. Such rotational speed indicates a potential of 5,800 to 6,900 RPM. These speeds typify the efficiency of the motor during a non-cutting environment. In actual cutting of vegetation, the rotational speed of the blade tip may be 12,000 to 18,000 feet per minute, again with the higher rotational speeds indicated when operating on line voltage. These speeds relate to approximately 4,300 to 6,500 RPM on each of the two blades providing 21 inch cutting diameter. Similar motors may be provided as previously described for implementation of the electric lawnmower of the present invention. Further, the horsepower at cutting speed may be anywhere from 1.5 to 2.0 HP with the battery capacity of approximately 480 watt hours as necessary. Excellent cutting at these speeds with either the single motor or dual motor implementation may be experienced with adequate blade speed, cutting action and suction experienced within the lawnmower deck or housing. Mulching may also be accomplished when operating at these speeds and may be increased by implementation of the boost feature previously described which would be available to both DC electric motors during operation in this embodiment if implemented in one of the many various boost and conserver implementations previously described. Referencing again FIG. 12, both motors are depicted in parallel combination with the such parallel connectivity, as one motor is loaded disproportionately due to various factors from either air resistance or vegetation and cutting resistance, the second motor slows down due to the reduced power available from the battery caused by the internal resistance and the higher amperage of the power supply as is depicted. Such self adjustment of the motor and hence blade speeds provides an automated self regulation of both motors.

Given the power supply and control embodiment depicted in FIG. 13, the user may select either AC or DC operation which places the two motors 552a and 552b in either series or parallel configuration. When in DC mode, the battery 52 supplies constant current and may result in better performance of the motors. Further, when placed in DC mode, the motors are in parallel and as one motor is loaded disproportionately the second motor may slow down due to the reduced power available from the battery pack caused by the internal resistance of the power supply design and motor configuration and higher amperage.

Turning to the alternative construction and embodiment of the power supply and control circuitry of FIG. 13, the power supply and control circuit 560 indicates that the dual DC motors 552A and 552B are connected to the output of the AC/DC power selection switch 521 which toggles the power supply of the circuit from the full bridge rectifier 501 when in the AC position and to the DC battery source 52 when in the DC position as is depicted. The output of the power selection switch 521 feeds the voltage meter shown which is connected in parallel with the double pole, double throw interlock handle switch 31. The interlock handle switch 31 toggles between short in the DC motors 552A and 552B through a resistor, R1 to ground and connecting the output of the power selection switch 521, a three pole double throw switch in this disclosed embodiment, through circuit breaker 28 to the dual DC motors 552A and 552B. When the power selection switch 521 is in the AC selection position, the dual motors M1 and M2 are connected in series thereby splitting the voltage output of the rectifier. In such operation, the full bridge rectifier may provide 120 VDC with 60V the seen by each motor. When the AC/DC power selection switch 521 is in the DC position, the motors M1 and M2 are connected in parallel thereby each sharing in the DC voltage output of the performance of the DC motors M1 and M2 in parallel and thus the connection as is described may be provided with the capability of switching between parallel and series connectivity of the motors M1 and M2 depending on the power source. Further, as disclosed in FIG. 13, a full bridge rectifier or possibly other current rectification is depicted wherein the 120V AC is input into the hybrid controller (not depicted as previously shown for simplicity). The full bridge rectifier in this embodiment may readily be replaced by known current rectification circuitry which have been previously disclosed herein or which are known in the art. Thus, the rectifier depicted may be replaced by other current rectification means to rectify the current from AC to DC. These known systems include but are not limited to pulse width modulation which may readily be implemented herein.

When AC mode is selected from the user selectable power selection switch shown in FIG. 13, the total current going through many of the switches and electronic circuit elements presented herein may be one half of that in the parallel or battery mode given the embodiments depicted as a result of the rectification of the current and positioning of the loads. In other words, as shown in FIG. 13, the battery pack provides 60 VDC which is shared by the dual motors in parallel and the AC input line provides 120 VDC to be split by the dual motors in series in the disclosed embodiments. The response to uneven loading also may be more desirable as previously described in parallel as opposed to in series mode since, when in series mode, as one motor is disproportionately loaded and slows down, the other motor will speed up. The actual speed modification of the motors in series however may be mitigated due to the nature of the air resistance to the blades and the significant amount of energy and load required to move the air in the mower housing. The relationship between air movement resistance and blade speed is an exponential relationship thus adding a significantly higher load the faster the blade thus tending to cause the blades to operate at similar speeds in these embodiments. However, either combination of either series or parallel connection of the two DC motors as is depicted may readily be implemented and such a description is set forth herein is not deemed limiting as a preferable implementation as one of ordinary skill necessarily requires.

In both configurations of the dual motor design depicted, the ability and functionality of the boost and conserve features are still present in that the blade speed for both motors may be reduced in a conserve mode, particularly when operating off of the DC battery power supply in order to increase charge life. As shown in FIG. 12, a boost and conserve switch and feature may be implemented in conjunction with the hybrid controller shown. However, many differing combinations of the boost and conserve feature previously described may be well understood to be applicable to either design and power supply shown. In conjunction with the power supply and control depicted in either embodiment, a secondary battery pack may be utilized as discussed herein to increase the voltage output of the DC operation and power supply thereby increasing the blade speed for both motors while also allowing battery use to be conserved in a second state thereby increasing overall run life per charge. Alternatively, increased voltage may be provided directly from the hybrid controller as depicted when drawing power from AC power supply.

In addition to the dual motor or other designs depicted, it may also be desirable to implement utilization of a dual voltage electric motor to rotate the blade as opposed to a dual motor twin blade approach. Such dual voltage may be seen by the electric motor when switching between rectified line voltage from an outlet or from a battery pack, which may, in one embodiment, roughly be one half the line voltage. When utilizing a dual voltage design for a larger cutting diameter, since only a single armature is being rotated, the load can be reduced depending on blade diameter and overall characteristics of the motor. However, most dual voltage motors have typically required dedicated coils for individual AC or DC operation. Such motor designs tend to be prohibitively expensive to implement as dedicated windings for a different power supply increases motor weight and expense. Further, typical designs have reduced efficiency of the motor as a result of their dedicated windings, armature and rotor design, brushes and commutator. It would be preferable that a dual voltage electric motor be implemented for hybrid operation wherein all electrical or electromechanical aspects of the electric motor are in operation and use when utilizing either high voltage operation or lower voltage windings, brushes, commutators and other aspects of the electrical motor are mostly in operation and electrically connected to the power supply, whether high voltage AC or lower voltage DC. However, many alternative constructions and embodiments may be implemented and are known and such presentation of the configuration of the hybrid electrical motor design presently described is not to be considered or construed as unduly limiting, as many alternative constructs are available to those skilled in the art to implement the dual voltage capability disclosed herein and the present embodiment of the hybrid controller and motor design is not intended to be specifically limiting. The described DC voltage permanent magnet motor design of the exemplary embodiment allows a single motor to operate using two different DC voltages. This may be accomplished through providing a hybrid controller which places electrically separated windings on the rotor in either serial or parallel configuration, parallel for lower voltage operation and serial configuration for higher voltage configuration. In either configuration, the voltage potential across each coil will be about 60 VDC, or half the high voltage, as the coils are placed in series when in AC mode and in parallel when in lower voltage mode. Similarly alternative constructions may be implemented in the embodiment shown.

Presently, in various embodiments depicted, a dedicated electric motor design may be implemented in the hybrid electric lawnmower depicted herein which implements the ability and functionality of direct AC power supplied from a standard line voltage power source providing 120V AC, or, providing power from a secondary power supply source such as a battery pack, which would supply about 60 VDC to about 72 VDC, as is necessary or as is designed, all to the same electric motor driving the blade on the mower housing. In one embodiment, the hybrid controller utilized in the embodiment may convert the 120V AC to 120 VDC through the use of various known techniques, such as a rectifier or other known circuit implementations. In such implementation, the user would elect to switch the mower power supply selection switch to AC, the hybrid controller would rectify the voltage to DC and the motor would operate at a possibly higher voltage supply. Alternatively, user selection of the power selection supply to the motor in order to operate the blade on the mower housing.

In either situation, user selection of AC operation as when the mower embodiment depicted is plugged into an outlet, or when user selection has been modified to DC operation for running the mower off of the battery pack or other direct current power supply, the electric mower of the present embodiment may alternate between high voltage operation or low voltage operation, the low voltage supply typically one half the high voltage supply. Through implementation of dual core windings which are electrically separated and both rated at the lower voltage level, the rpm of the hybrid motor presently described may be maintained in either voltage configurations.

In the electric motor of this alternative embodiment, there may be two separate windings on the same rotor, each set of windings being electrically separated from the other. The first set of windings may be electrically connected to a first commutator, the second set of windings may be electrically connected to a second commutator. The first commutator may be located a first end of the armature, the second commutator located at a second substantially distal end of the armature. A permanent magnet may be placed around the armature as is known.

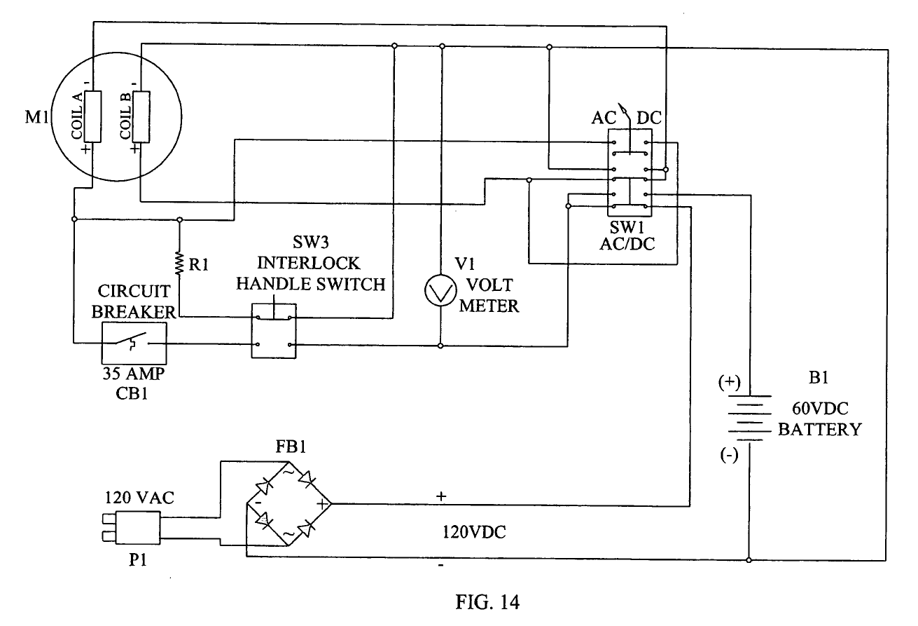

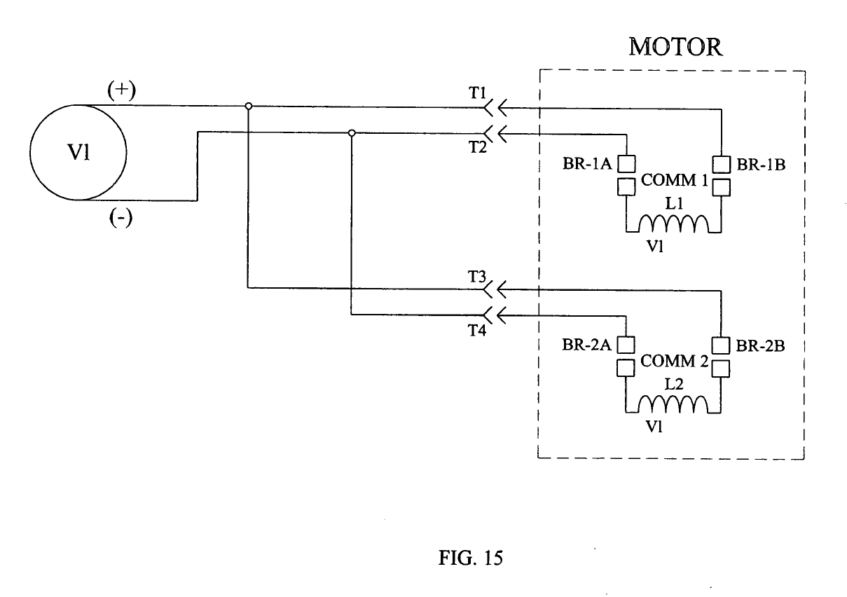

FIG. 14 depicts an exemplary circuit implementation for the hybrid controller and electric motor described wherein the motor M1 operating to turn the blade on the mower housing has a first set of coils coil L1 and a second set of coils coil L2 in electrical isolation around the rotor. Coil L1 has a first commutator COMM1 at a first end of the rotor which is in electrical contact with first pair of brushes BR1A and BR1B shown in FIG. 15. BR1A is connected to terminal T2 while brush BR1B is connected to terminal T1. Additionally, second coil L2 is connected to commutator COMM2 at a second end of the rotor which is in electrical contact with second pair of brushes BR2A and BR2B, brush BR2A in electrical communication with terminal T4 and brush BR2B in electrical communication with terminal T3.

As depicted in both FIGS. 14 and 15, the coils may be placed in either a high voltage configuration or a low voltage configuration by the user, the high voltage configuration placing coils L1 and L2 in series and the low voltage configuration placing the coils L1 and L2 in parallel. User selection of the high or low voltage configuration provides the operator of the hybrid mower presently described in this embodiment the ability to provide a power supply of 120V AC for higher voltage operation or 60-72 VDC for lower voltage operation. Similarly, as previously described, volt meter V1, interlock handle switch SW3 and circuit breaker CB1 may be integrated into the hybrid controller 530 as previously discussed. A full bridge rectifier FB1 may be utilized to provide rectification of the 120V AC to a rectified supply. Other means of voltage recitification may be implemented as is known in the art and these many known AC to DC voltage rectification means are incorporated herein.

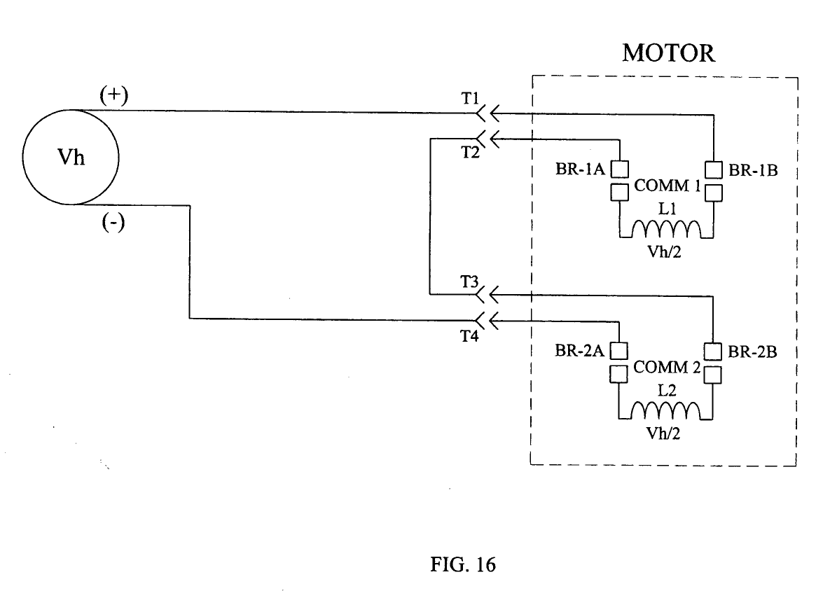

As depicted in FIGS. 15-16, when in low voltage configuration or when user operation is in the DC mode and switch SW1 is set to DC, both commutators COMM1 and COMM2 and therefore both coils L1 and L2 are connected in parallel with each other. In such a parallel configuration the positive terminal of the V1 voltage source is connected to the terminal T1 of the motor and the negative terminal of the V1 voltage source is connected to the terminal T2 of the hybrid motor. Terminals T1 and T2 are connected to the first commutator COMM1 through brushes BR1A and BR1B which creates a voltage potential of V1 across the first coil L1. The positive terminal of the V1 voltage source is also connected to terminal T3 of the motor and the negative terminal of the V1 voltage source is also connected to terminal T4. The terminals T3 and T4 are connected to the second commutator COMM2 through brushes BR2A and BR2B. This will create a voltage potential of V1 across the second coil L2.

When in high voltage configuration, both commutators COMM1 and COMM2 and therefore both sets of coils L1 and L2 are connected in series with each other. In the series configuration, the positive terminal of the V1 voltage source is connected to terminal T1 of the motor and the negative terminal of the V1 voltage source is connected to terminal T4 of the motor. Terminal T2 is connected to terminal T3. Terminals T1 and T2 are connected to the first commutator COMM1 through brushes BR1A and BR1B and terminals T3 and T4 are connected to the second commutator COMM2 through the brushes BR2A and BR2B. This will create a voltage potential of Vh across both coils which means that each coil will have a potential of ½ Vh or V1 in the present embodiment. While the hybrid mower has been described for many embodiments, the invention presented is not limited to the specific structures provided. The invention and claims are intended to cover various modifications and equivalent arrangements included within the spirit and scope of the appended claims and teachings hereof. The scope of the claims is to be accorded the broadest interpretation so as to encompass all such modifications and equivalent structures and functions.

I claim:

1. A hybrid mower for operation in AC or DC mode, comprising:
a permanent magnet motor mounted to a mower housing and turning a blade, said motor controlled by a hybrid controller, said controller having a user selection switch of low voltage and high voltage;
said motor having a first coil electrically separated from a second coil, both of said first and said second coil wrapped on a rotor of said motor;
a hybrid controller including a user selection switch selectively connecting said motor to a battery pack and to a high voltage DC source, said high voltage DC source about double the voltage provided by said batter pack;
wherein said motor includes a first commutator in electrical contact with said first coil and a second commutator in electrical contact with said second coil, said first and said second commutator on opposite ends of said rotor and being in contact with first and second brushes;
said user selection switch operable to electrically connect said first coil and said second coil in a first series connection and in a second parallel connection.

2. The mower of claim 1 wherein said user selection switch is a three pole double throw switch selectively connecting said motor to said high voltage power supply or to a lower voltage power supply.

3. The mower of claim 1 wherein said high voltage DC source is rectified from 120V AC.

4. The mower of claim 1 further comprising an interlock handle switch positioned on said mower, said interlock handle switch electrically interposed between said user selection switch and said first and said second coil to inactivate said motor when said switch is open.

5. An electric lawn mower operable to run from AC line voltage and lower voltage DC, comprising:
a mower having a mower deck and an electric motor mounted on said deck and turning a blade; selection switch switchable between AC and DC operation;
wherein said motor has a first coil electrically separated from a second coil, said first coil in electrical contact with a first commutator, said second coil in electrical contact with a second commutator, said first and second commutator being in contact with first and second brushes;
said user selection switch operable to electrically connect said first coil in series with said second coil when placed in a first position, and operable to electrically connect said first coil in parallel with said second coil when placed in a second position.

6. The electric lawn mower of claim 5 wherein said user selection switch is a triple pole double throw switch.

7. The electric lawn mower of claim 6 wherein said motor is placed in electrical connectivity to a high voltage DC source when said user selection switch is placed in first orientation and wherein said motor is placed in electrical connectivity to a lower voltage DC source when said user selection switch is placed in a second orientation.

8. The electric lawn mower of claim 7 wherein said high voltage DC source is a rectified 120V AC.

9. The electric lawn mower of claim 7 wherein said lower voltage source is a batter pack.

10. The electric lawn mower of claim 9 wherein said battery pack has about 60 VDC potential.

11. A dual voltage electric lawn mower comprising:
a dual voltage electric motor mounted to a mower housing and connected to a user selection switch mounted on said mower;
a blade rotating on said housing and connected to said electric motor;
a battery pack and an AC input line in electrical connectivity with said user selection switch;
said dual voltage motor having a first set of windings and a second set of windings on an armature and in electrical connectivity with said user selection switch; setting configuring said first and said second set of windings in parallel relationship, said second setting configuring said first and said second set of windings in series relationship.

12. A dual voltage electric lawn mower, comprising:
an electric mower having a dual voltage electric motor powering a blade on a housing;
first and second windings on said motor;
switch circuit means configuring said first and second windings in a first parallel relationship when in a first position and in a second series relationship when in a second position;
a high voltage source connected to said motor when said switch means is in said second position;
a low voltage source connected to said motor when said switch means is in said first position.

13. The mower of claim 12 wherein said switch circuit means includes a triple pole double throw switch.

14. The mower of claim 13 wherein said low voltage source is a batter pack.

15. The mower of claim 13 wherein said high voltage source is 120V AC.
